(19) United States
(12) Patent Application Publication
(10) Pub. No.: US 2003/0215629 A1
(43) Pub. Date: Nov. 20, 2003

(54) Wedge grip tape for handle

(76) Inventor: Sam H. Chen, San Diego, CA (US)

Correspondence Address: CALIF KIP TERVO, 6387 CAMINITO LAZARO, SAN DIEGO, CA, 92111, US

(21) Appl. No.: 10/151,084

(22) Filed: May 16, 2002

(51) Int. Cl. B32B 27/04; B32B 5/02; B32B 15/04

(52) U.S. Cl. 428/343; 442/149

(57) ABSTRACT

A grip tape 10 for applying to a handle 92 generally comprises top 20, bottom 30, left side 40, and right side 50; wherein tape 10 is substantially wedge shaped in lateral cross section defining a thick side 60, a thin side 70, and an included angle 14. Top 20 includes an upper layer 22 of polyurethane having an outer surface 25 for gripping and an inner layer 26 comprising an open-pored textile, such as felt. Bottom 30 includes a resilient wedge 32.

Tape 10 is wrapped around grip portion 93 of handle 92 with thick side 60 nearer butt 96. Tape 10 is wrapped around handle 92 adjacent butt 96 so as to form a stop 36.

### BACKGROUND OF THE INVENTION

1. Field of the Invention

This invention relates to an improved grip tape for the handle of a racquet or other hitting device, such as a hammer, golf club, or baseball bat, that is swung and subject to shock when the device is impacted.

2. Background of the Invention

Grip tape for wrapping a racquet handle to enhance grip and/or to reduce shock is well-known. Grip tapes have been made of leather, rubber, and plastic. One type of conventional grip tape comprises a layer of polyurethane backed with a layer of felt. The felt layer is generally thicker than the polyurethane layer and provides part of the elasticity, strength, cushioning, and shock resistance. The polyurethane layer provides a tacky gripping surface and part of the cushioning and shock resistance.

In lateral cross section, conventional grip tape is roughly rectangular. The outside edges of the bottom of the tape may be skived (beveled) such that the tape can be spiral wrapped with overlapping edges without welts being formed by the overlapped edges.

As the handle is swung, it tends to pull out of the user's hand. There has been a need for a grip tape that more directly addresses this problem.

Also, it is desirable in some circumstances to have a skirt or stop adjacent the butt of the handle to prevent the handle from completely slipping from the user's hand or for providing greater grip.

### SUMMARY OF THE INVENTION

This invention is a grip tape for applying to a handle and it generally comprises a top, a bottom, a left side, and a right side; wherein the tape is substantially wedge shaped in lateral cross section defining a thick side, a thin side, and an included angle. The top includes an upper layer of a first material, such as polyurethane, having an outer surface for gripping, and an inner layer comprising an open-pored textile, such as felt. The bottom includes a resilient wedge of a second material. The tape is wrapped around the grip portion of the handle with the thick side nearer the butt. In an alternative embodiment, the tape includes a first section as described above adapted for wrapping around the handle adjacent the butt so as to form a stop and a second section of conventional grip tape joined to the first section for spiral wrapping over the handle.

In a combination, the butt portion includes a protrusion protruding radially outward from the outer surface of the adjoining grip portion and the thick side of said tape has a thickness at least equal to the height of the protrusion. In a second combination, the tape is wrapped around the grip portion adjacent said butt with the thick side nearer the butt multiple times in a substantially overlapping wrap such that the combined thickness of the wrapped tape is at least equal to the height of the protrusion.

Other features and many attendant advantages of the invention will become more apparent upon a reading of the following detailed description together with the drawings in which like reference numerals refer to like parts throughout.

### BRIEF DESCRIPTION OF THE DRAWINGS

FIG. 1 is a perspective view of the handle of a sporting racquet with a preferred embodiment of the wedge grip tape of the invention wound around the handle.

FIG. 2 is an enlarged lateral cross sectional view taken on line 2-2 of the grip tape of FIG. 1.

FIG. 3 is a longitudinal cross sectional view, partially cut away, of the grip tape and handle of FIG. 1.

FIG. 4 is a lateral cross sectional view of a second embodiment of grip tape including a wedge section followed by a flat section.

FIG. 5 is a lateral cross sectional view of a third embodiment of grip tape including a single wrap wedge section followed by a flat section.

### DETAILED DESCRIPTION OF THE INVENTION

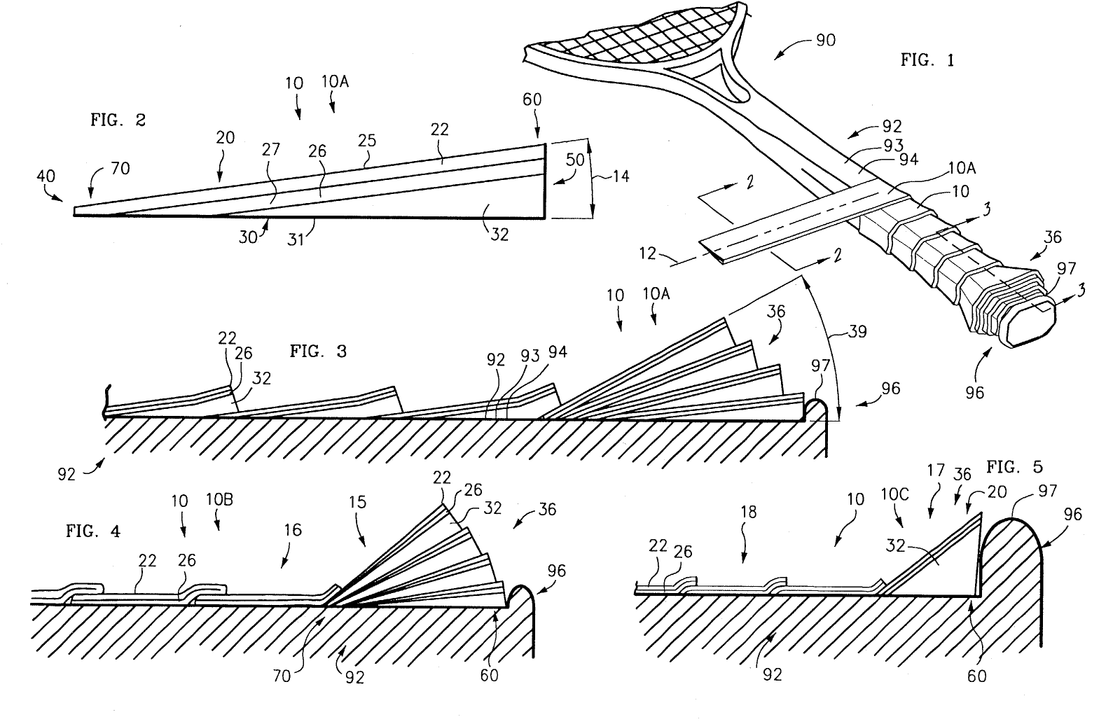

With reference now to FIGS. 1-3 of the drawings, FIG. 1 is a perspective view of the handle 92 of a hitting device, such as a sporting racquet, such as tennis racquet 90, with a first embodiment 10A of the grip tape 10 of the invention wound around handle 92. FIG. 2 is an enlarged lateral cross sectional view taken on line 2-2 of tape 10A of FIG. 1. FIG. 3 is a longitudinal cross sectional view, partially cut away, of tape 10A and handle 92 of FIG. 1.

Tape 10A is elongate with a longitudinal axis 12. Tape 10A has a top 20 having an outer surface 25 for gripping, a bottom 30, a left side 40, and a right side 50. Tape 10A is substantially wedge shaped in lateral cross section throughout its length so as to define a thick side 60, a thin side 70, and an included angle 14.

Top 20 includes an upper layer 22 of a first material, such as of thermoplastic rubber, polyurethane synthetic leather, or leather, as are known in the art, having an outer surface 25 for gripping. Bottom 30 includes a resilient wedge 32 of a second material, such as of rubber, synthetic rubber or EVA, below upper layer 22. Tape 10 may include a layer of glue, adhesive or two-sided tape (not shown) on all or part of outer surface 31 of bottom 30 to aid adhesion to handle 92.

Top 20 includes an inner layer 26 of a third material, such as an open-pored textile, such as felt 27, disposed between upper layer 22 and wedge 32. Felt layer 27 provides part of the elasticity, strength, cushioning and shock resistance. Upper layer 22, inner layer 26 and wedge 32 are attached, such as by adhesive as is well known in the art.

Dimensions of the elements of tape 10 vary depending upon the application. Typical dimensions for tape 10, such as 10A, would be: width, 10-35 mm; upper layer thickness 0.5-1.0 mm, and inner layer thickness, 0.3-1.0 mm. Thick side thickness of 4.0-5.0 mm and thin side thickness of 0.4-2.0 mm. Included angle 14 is typically five degrees or more.

In the exemplary embodiment of FIGS. 1 and 3, tape 10A is wrapped on outside surface 94 of grip portion 93 of handle 92 with thick side 60 nearest butt 96. Butt 96 includes a flange or protrusion 97 protruding radially outward from outer surface 94 of adjoining grip portion 93. Tape 10A is wrapped around grip portion 93 of handle 92 adjacent butt 96 with thick side 60 nearest butt 96 multiple times in a substantially overlapping wrap so as to form skirt wedge or stop wedge 36 having an included angle 39 equal to the combined included angles 14 of the wraps. Stop wedge 36 aids in preventing the user's hand from sliding off butt end 96 of handle 92 and provides purchase. As best seen in FIG. 3, tape 10A is spiral wrapped around the remainder of grip portion 93 of handle 92 such that bottom 30 overlies thin side 70 of the previous turn. Alternatively, all of tape 10A can be spiral wrapped such that there is no stop wedge 36.

FIG. 4 is a lateral cross sectional view of a second embodiment 10B of grip tape 10. Tape 10B includes a first section 15 adapted for wrapping around handle 92 adjacent butt 96 so as to form stop wedge 36. First section 15 of tape 10B is the same as 10A above. Tape 10B includes a second section 16 joined to first section 15 with a smooth transition. Second section 16 may be configured as conventional tape, and is adapted for spiral wrapping over handle 92.

FIG. 5 is a lateral cross sectional view of a third embodiment 10C of grip tape 10 including a single wrap wedge section 17 followed by second section 18. Wedge section 17 includes a thick wedge 32 such that the thickness of thick side 60 of tape 10C is at least equal to the height of protrusion 97. Wedge 32 may be integral with top 20 of tape 10C or may be a separate part that is attached to top 20 such as with adhesive or glue. Tape 10C is made or cut so that wedge section 17 will make one wrap around grip portion 93 adjacent butt 96 with thick side 60 nearer butt 96. Tape 10C includes a second section 18 joined to first section 17. Second section 18 may be just top portion 20 and is configured as conventional tape and is adapted for spiral wrapping over handle 92.

Having described the invention, it can be seen that it provides for an improved tape for aiding in gripping a handle. In the description and claims, the terms “left” and “right” have been used for convenience of description and, of course, are reversible as a whole due to symmetry.

Although a particular embodiments of the invention has been illustrated and described, various changes may be made in the form, composition, construction, and arrangement of the parts without sacrificing any of its advantages. Therefore, it is to be understood that all matter herein is to be interpreted as illustrative and not in any limiting sense, and it is intended to cover in the appended claims such modifications as come within the true spirit and scope of the invention.

1. A tape for wrapping a handle said tape having a longitudinal axis and including:
a top having an outer surface for gripping;
a bottom;
a left side; and
a right side; wherein said tape is substantially wedge shaped in lateral cross section defining a thick side, a thin side, and an included angle.

2. The tape of claim 1 wherein:
said top includes:
an upper layer of a first material having an outer surface for gripping; and
said bottom includes:
a resilient wedge of a second material below said upper layer.

3. The tape of claim 2 wherein said top includes:
an inner layer between said upper layer and said resilient wedge; said inner layer comprising an open-pored textile.

4. The tape of claim 1 wherein:
the included angle is at least five degrees.

5. The tape of claim 1 wherein:
said bottom includes an outer surface including an adhesive.

6. A tape for wrapping a handle having a butt; said tape having a longitudinal axis and including:
a first section adapted for wrapping around the handle adjacent the butt so as to form a stop; said first section comprising;
a top having an outer surface for gripping;
a bottom;
a left side; and
a right side; wherein said first section is substantially wedge shaped in lateral cross section defining a thick side and a thin side and an included angle; and
a second section joined to said first section; said second section not being wedge shaped in lateral cross section and being adapted for spiral wrapping over the handle; said second section including:
an outer surface for gripping.

7. The tape of claim 6 wherein:
said top of said first section includes:
an upper layer having an outer surface for gripping; and
said bottom of said first section includes:
a resilient wedge below said upper layer.

8. The tape of claim 7 wherein said first section includes:
an inner layer between said upper layer and said resilient wedge; said inner layer comprising an open-pored textile.

9. The tape of claim 6 wherein:
the included angle is at least five degrees.

10. The tape of claim 6 wherein:
said bottom includes an outer surface including an adhesive.

11. In combination:
a handle; and
a tape having a longitudinal axis wrapped around said handle; said tape including:
a top having an outer surface for gripping;
a bottom;
a left side; and
a right side; wherein said tape is substantially wedge shaped in lateral cross section defining a thick side and a thin side and an included angle.

12. The combination of claim 11 wherein:
said handle includes:
a butt; and
said tape is wrapped around the handle with the thick side nearer said butt.

13. The combination of claim 11 wherein:
said handle includes:
a grip portion having an outer surface; and
a butt portion adjoining said grip portion; said butt portion including a protrusion protruding radially outward from said outer surface of said adjoining grip portion; and wherein:
the thickness of said thick side of said tape is at least equal to the height of said protrusion and said tape is wrapped around said grip portion adjacent said butt with the thick side nearer said butt.

14. The combination of claim 11 wherein:
said handle includes:
a grip portion having an outer surface; and
a butt portion adjoining said grip portion; said butt portion including a protrusion protruding radially outward from said outer surface of said adjoining grip portion; and wherein:
said tape is wrapped around said grip portion adjacent said butt with the thick side nearer the butt multiple times in a substantially overlapping wrap such that the combined thickness of said wrapped tape is at least equal to the height of said protrusion.

15. The combination of claim 11 wherein:
said handle includes:
a butt; and
said tape is wrapped around the handle adjacent said butt with the thick side nearer the butt multiple times in a substantially overlapping wrap so as to form a stop having an included angle equal to the combined included angles of said wrapped tape.

16. The combination of claim 11 wherein:
said tape is spiral wrapped around said handle such that said bottom overlies said thin side of the previous turn.

17. The combination of claim 11 wherein:
said handle includes:
a butt; and
said tape is spiral wrapped around said handle with thick side nearer the butt such that said bottom overlies said thin side of the previous turn.

18. A method of enhancing grip on a handle including a butt; said method comprising the steps of:
wrapping the handle with a tape having a longitudinal axis and including a top having an outer surface for gripping, a bottom, a left side, and a right side; wherein the tape is substantially wedge shaped in lateral cross section defining a thick side and a thin side.

19. The method of claim 18 wherein the step of wrapping includes wrapping the tape around the handle with the thick side nearer the butt.

20. The method of claim 18 wherein the step of wrapping includes wrapping the tape around the handle in a helix such that the bottom overlaps the thin side of the previous wrap.

21. The method of claim 20 wherein the step of wrapping includes wrapping the tape around the handle with the thick side nearer the butt.

22. The method of claim 18 wherein the step of wrapping includes wrapping the tape adjacent the butt with thick side nearer the butt with a substantially overlapping wrap so as to form a stop.
